(19) United States
(12) Patent Application Publication
(10) Pub. No.: US 2003/0118764 A1
(43) Pub. Date: Jun. 26, 2003

(54) Composite fluid distribution and fluid retention layer having machine direction zones and Z-direction gradients for personal care products

(76) Inventors: Ricky Alton Adams, Cumming, GA (US); Leon Eugene Chambers JR., Marietta, GA (US); Robert G. Geer, Canton, GA (US); Lamar Heath Gipson, Acworth, GA (US); Eric Edward Lennon, Roswell, GA (US); Lewis Thomas Nicholson, Atlanta, GA (US); Sridhar Ranganathan, Suwanee, GA (US); James R. Sanders, Cumming, GA (US); Jerome Joseph Schwalen, Marietta, GA (US); Richard Norris Dodge II, Appleton, WI (US); Lawrence Howell Sawyer, Neenah, WI (US)

Correspondence Address: PAULEY PETERSEN KINNE & ERICKSON, 2800 WEST HIGGINS ROAD, SUITE 365, HOFFMAN ESTATES, IL, 60195, US

(21) Appl. No.: 10/037,450

(22) Filed: Dec. 20, 2001

(51) Int. Cl. B32B 1/08

(52) U.S. Cl. 428/36.91; 428/36.9

(57) ABSTRACT

An in-line formed web having major surfaces in the X-Y plane and a depth in the Z direction is suitable for use as a composite fluid distribution and fluid retention layer in a disposable absorbent article. The web contains multiple layers of composite material which may have both thermoplastic fibers and absorbent material. The multiple layers can have different compositions of thermoplastic fibers and absorbent material as applied in-line by various arrangements of thermoplastic melt dies and absorbent fiber dispensers. By arranging at least two of the multiple layers in an opposing relation overlaid in the Z-axis direction of the web, a gradient can be formed in the Z-direction of the web. By coordinating the timing and deposition of the material onto a forming wire, at least one of the multiple layers is arranged to have zones of intermittent material deposition in at least one of a machine direction or a cross direction of the web. Thus the in-line formed composite web has a Z-direction gradient of air laid material layers and zones of different material layers intermittently placed in one of the machine direction or the cross direction and may be customized according to the specific need for a single composite structure having fluid intake, distribution and retention properties in an absorbent article.

### BACKGROUND OF THE INVENTION

Personal care products typically are made with a top sheet material (also referred to as a cover sheet or liner), an absorbent core and a liquid impervious back sheet. Some may also have a surge layer or other specialized layers between the top sheet and absorbent core. Absorption of fluid, comfort and avoidance of leakage are the functions desired.

An ideal absorbent product, such as the personal care products discussed herein in conjunction with the present invention, would have no leakage and deliver comfort and discretion to the user. Current personal care products may have relatively high leakage and thus offer only modest protection to the consumer. All leakage is categorized by three key causes: fluid does not absorb into the product, fluid is absorbed into the product but subsequently leaves it, or fluid never contacts the product.

The specific reasons for leakage may be expressed further in terms of definitive mechanisms. A product, for instance, may not have suitable space for absorption due to localized saturation or low contact area. The product may not have a suitable driving force for absorption because the structure does not have the right balance of permeability and capillarity. The interfiber spaces may be partially full of fluid. Fluid may contact the pad and run-off. The fluid may be too viscous or the pores or interfiber spaces are not large enough to allow fluid to pass through to the subjacent layer.

In all cases, the material systems and their concentration in a specific product design dramatically impact leakage. In the field of material systems design, leakage is a function of materials shaping and conformability as well as intake, distribution, retention and transfer.

Intake includes the initial absorption of fluid into a dry product as well as the continued uptake of that fluid into the absorbent structure. Development of superior intake systems requires an understanding of environmental conditions including the nature of the fluid and its discharge. Developing functional intake structures requires an understanding of material characteristics and their interaction with the fluid as components and systems of components including interfaces and product design. Product design includes the arrangement and geometric design of material components and their interaction with the body and fluid.

Initial intake of bodily fluids into an absorbent article is also a function of the characteristics of the liner or topsheet material and the upper absorbent layer.

Intake of bodily fluid into these materials is a function of the material characteristics including the ratio of void volume to fiber surface area, fiber orientation and fiber surface wettability. These intrinsic material characteristics specifically define the more familiar material properties of permeability, capillarity and fiber wettability which can be calculated and measured by techniques well known in the art. Regardless of the characteristics of the liner, a suitable intermediate layer and absorbent core must be matched to it to permit fluid communication and transfer and thus good fluid intake.

There remains a need for a personal care product that is able to contain body exudates in such a way as to keep the wearer comfortable and protected from fluid being expressed out of the absorbent article.

As is known in the art, personal care products such as diapers or other absorbent garments are often constructed from multiple layers of materials with each layer having a specialized function. For example, two common layers are the surge layer, specialized for the rapid distribution of bodily fluids away from the point of insult to the product and the absorbent layer which is specialized to hold and retain a high volume, or load, of liquid. However, the construction of garments with specialized layers, which may be functionally very efficient, may also lead to escalating product costs due to the expense of making and placing the multiple layers together in a garment. Thus, it is further desirable that the fluid handling, or distribution, layer and the fluid absorbent, or retention layer be easily manufactured and incorporated into a personal care product in an economical fashion.

### SUMMARY OF THE INVENTION

In response to the discussed difficulties and problems encountered in the prior art a new multifunctional composite web has been discovered which provides fluid intake, distribution and retention functions. Personal care products using this composite are also contemplated to be within the scope of this invention.

One such personal care product has a liquid impermeable backsheet, a liquid permeable topsheet, and the multifunctional composite web located between the topsheet and backsheet. The multifunctional composite web, hereinafter sometimes referred to simply as the web, according to one embodiment of the present invention is an on-line formed web having major surfaces in the X-Y plane and a depth in the Z direction that is suitable for use as a fluid intake, distribution and retention layer in a disposable absorbent article.

The web contains multiple layers of material, such as composites which may have both binders, such as thermoplastic fibers, and absorbent material, such as pulp or the like, as deposited in an airlaid process. The multiple layers may have different compositions of, binders, such as, thermoplastic fibers, and absorbent material as applied in-line by various arrangements of thermoplastic melt dies and absorbent fiber dispensers. By arranging at least two of the multiple layers in an opposing relation overlaid in the Z-axis direction of the web, a gradient can be formed in the Z-direction of the web thereby providing fluid intake and distribution (hereinafter referred to simply as “fluid distribution”) functions when placed in that portion of the personal care product closest to the topsheet, or otherwise closest to the wearer if the topsheet is not desired or necessary. Another area of the composite web may then provide fluid retention functions without the necessity of making, handling, and constructing separate layers together into the personal care product.

By coordinating the timing of the material deposition onto a forming wire having a controlled area vacuum, at least one of the multiple layers can be arranged to have zones of intermittent material deposition in at least one of a machine direction or a cross direction of the web. Thus the on-line formed composite web has a Z-direction gradient of air laid material layers and zones of different material layers intermittently placed in one of the machine direction or the cross direction and may be customized according to the specific need for a single composite structure having fluid distribution and retention properties in an absorbent article.

### BRIEF DESCRIPTION OF THE DRAWINGS

FIG. 1 is a schematic diagram of a first embodiment of the composite web having two layers.

FIG. 2 is a schematic diagram of a second embodiment of the composite web being an alternative to FIG. 1.

FIG. 3 is a schematic diagram of a third embodiment of the composite web showing variation of the zonal deposition of the materials in the second layer.

FIG. 4 is a schematic diagram of a fourth embodiment of the composite web showing zonal deposition of absorbent particle concentration in the second layer and showing zonal deposition of the amount, or density, of the layer material in the third layer.

FIG. 5 is a schematic diagram of a fifth embodiment of the composite web showing zonal and gradient deposition of absorbent particle concentration in a first layer, and zonal and gradient construction of the second layer and the third layer interspersed between the first layer.

### DEFINITIONS

“Disposable” includes being disposed of after a single, or limited, use and not intended to be washed and reused.

A “layer” is defined as a generally recognizable combination of similar material types or function existing in the X-Y plane.

The “upward” or “top” position layers are closer to the body of a wearer than “downward” “lower” or “bottom” layers when the article is worn.

“Composite” is defined as having two or more discrete components.

As used herein and in the claims, the term “comprising” is inclusive or open-ended and does not exclude additional uncredited elements, compositional components, or method steps.

As used herein the term “nonwoven fabric or web” means a web having a structure of individual fibers or threads which are interlaid, but not in an identifiable manner as in a knitted fabric. Nonwoven fabrics or webs have been formed from many processes such as for example, meltblowing processes, spunbonding processes, and bonded carded web processes. The basis weight of nonwoven fabrics is usually expressed in ounces of material per square yard (osy) or grams per square meter (gsm) and the fiber diameters useful are usually expressed in microns. (Note that to convert from osy to gsm, multiply osy by 33.91).

“Spunbond fibers” refers to small diameter fibers that are formed by extruding molten thermoplastic material as filaments from a plurality of fine capillaries of a spinneret. Such a process is disclosed in, for example, U.S. Pat. Nos. 3,802,817 to Matsui et al., 4,340,563 to Appel et al. The fibers may also have shapes such as those described, for example, in U.S. Pat. No. 5,277,976 to Hogle et al. which describes fibers with unconventional shapes.

“Airlaying” is a well-known process by which a fibrous nonwoven layer can be formed. In the airlaying process, bundles of small fibers having typical lengths ranging from about 1 to about 19 millimeters (mm) are separated and entrained in an air supply and then deposited onto a forming screen, usually with the assistance of a vacuum supply. The randomly deposited fibers then are bonded to one another using, for example, hot air, water compaction, or a spray adhesive. Airlaying is taught in, for example, U.S. Pat. No. 4,640,810 to Laursen et al. Air laying may include coform deposition which is a known variant wherein pulp or other absorbent fibers are deposited in the same air stream onto the forming screen. The screen may also be referred to herein as a forming wire.

“Personal care product” means diapers, wipes, training pants, absorbent underpants, adult incontinence products, feminine hygiene products, wound care items like bandages, and other articles.

Words of degree, such as “about”, “substantially”, and the like are used herein in the sense of “at, or nearly at, when given the manufacturing and material tolerances inherent in the stated circumstances” and are used to prevent the unscrupulous infringer from unfairly taking advantage of the invention disclosure where exact or absolute figures are stated as an aid to understanding the invention.

As used herein, the term “machine direction” or MD means the length of a fabric in the direction in which it is produced. The term “cross direction” or “cross machine direction” or CD means the width of fabric, i.e. a direction generally perpendicular to the MD.

“In-line” refers to a continuous process for forming an integral web on a single forming line, as opposed to a material constructed from multiple webs formed on multiple lines and then put together as component pieces.

“Discrete material boundaries” refer to boundaries formed between identifiable layers such as resulting from post-processing after layer formation, including, but not limited to, such processing as applying adhesives to bond separate layers, applying interlayer films or tissues, and thermal or mechanical bonding of layer boundaries creating discrete bonding lines.

“Zone” refers to an area of relatively uniform material composition or concentration, or both, occurring in the plane of the X-Y axis, e.g., in a layer.

“Gradient” refers to a change of material composition or concentration, or both, occurring in the Z-axis, e.g. between layers.

### DETAILED DESCRIPTION OF THE PRESENTLY PREFERRED EMBODIMENTS

The absorbent composites of this invention, as further explained below, may be made using the air laid process. The production of air laid nonwoven composites is well defined in the literature and documented in the art. Examples include the Dan-Web process as described in U.S. Pat. No. 4,640,810 to Laursen et al. and assigned to Scan Web of North America Inc., the Kroyer process as described in U.S. Pat. Nos. 4,494,278 to Kroyer et al. and 5,527,171 to Soerensen assigned to Niro Separation a/s, the method of U.S. Pat. No. 4,375,448 to Appel et al. assigned to Kimberly-Clark Corporation, or other similar methods.

In an exemplary practice of this invention an absorbent composite having at least two layers is produced by the air laid process. The number of layers may be limited in present practice by equipment constraints as most airlaying equipment currently available generally has three to seven banks of airlaying heads. However, the present invention should not be considered as so limited if it is economical or otherwise practical to produce alternative fiber deposition equipment. Further, the person having ordinary skill in the art will recognize that other forms of deposition, such as air-formed processes without thermoplastic binders, may be practiced according to the present invention.

The composite generally has denominated an upper layer and a lower layer wherein the upper layer is the layer closer to the body of a wearer while the personal care product is in use. The composite web may have various gradients in the Z, or thickness, direction, including e.g., having a gradient of increasing density in the direction away from the wearer when the product is in use or otherwise. The composite web will also have zone, or zonal, depositions of materials as separated from each other along at least one axis of the major X-Y, or flat, planes of the web as will be understood by those of skill in the art. The major axes of the web will be indicated in the drawings where appropriate, with the thickness being indicated in the Z-direction, the X axis being indicated as the machine direction (MD) and the Y axis being indicated as the cross, or cross machine, direction (CD) for ease of explanation.

Referring to FIG. 1, the upper layer 20 of an exemplary embodiment of the composite web 23 is a 400 gsm layer made of treated or untreated pulp cellulose fiber in an amount of about 46 weight percent, with about 4 weight percent thermoplastic bicomponent staple fiber binder, and about 50 weight percent of a particulate superabsorbent such as commercially available Favor® 880, available from Stockhausen of Greensboro, N.C. A zone A 21 within the upper layer 20 may, e.g. contain little or no particulate superabsorbent to promote fluid intake and distribution. The binder is preferably a sheath/core, polyethylene/polyester bicomponent fiber such as available from KoSa Inc., as further detailed below.

The lower layer 25 is a 500 gsm layer made about 56 weight percent southern softwood pulp, about 4 weight percent binder, and about 40 weight percent of a like particulate superabsorbent. The layers 21, 25 may use the same type pulp and superabsorbent, the same pulp and different superabsorbents; or different pulps and superabsorbents as the application of the web dictates. Further the listed weight percents may be varied and additional materials added, or present materials deleted, as dictated by optimum functionality for the chosen application. Besides Favor 880 for example, Favor® 9543 or other commercial equivalents thereof, may be used as a superabsorbent material. Besides Weyerhaeuser NB416 southern softwood pulp, for example, Foley fluff from Buckeye Corporation Memphis, Tenn., may be used as a pulp material.

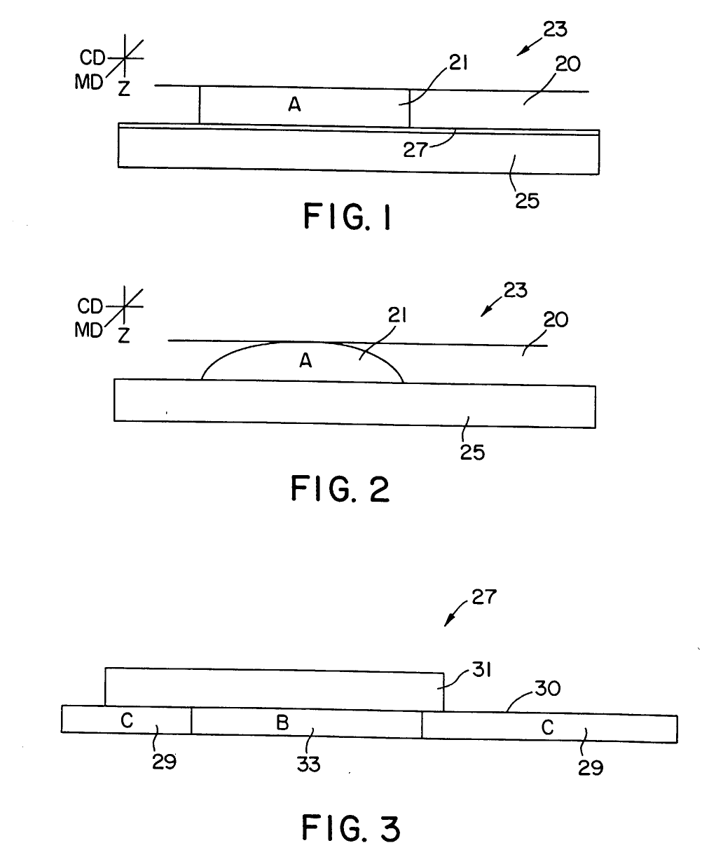

Comparing FIGS. 1 and 2 it can be seen that the embodiment of FIG. 1 has additional tissue layer 27 applied in-line and separating the top layer 21 from the bottom layer 25, whereas the top and bottom layers 21, 25 of FIG. 2, can be of the same components as the embodiment of FIG. 1, but are not separated by a tissue layer. Either embodiment is contemplated by the present invention. It will further be seen that the top layer 21 of FIG. 2 is somewhat more rounded in aspect, and may be more easily accomplished than the squared aspect of FIG. 1.

Binders typically used in these structures help provide mechanical integrity and stabilization. Binders may include fiber, liquid or other binder means which in some instances may be thermally activated. Preferred fibers for inclusion are those having a relatively low melting point such as polyolefin fibers. Lower melting point polymers provide the ability to bond the fabric together at fiber crossover points upon the application of heat. In addition, fibers having a lower melting polymer, like conjugate and biconstituent fibers are suitable for practice of this invention. Fibers having a lower melting polymer are generally referred to as “fusible fibers”. By “lower melting polymers” what is meant are those having a melting temperature less than about 175 degrees C. It should be noted that the texture of the absorbent web can be modified from soft to stiff through selection of the glass transition temperature of the polymer. Exemplary binder fibers include conjugate fibers of polyolefins, polyamides and polyesters. Some suitable binder fibers are sheath core conjugate fibers available from KoSa Inc. (Charlotte, N.C.) under the designation T-255 and T-256 or copolyester designation, though many suitable binder fibers are known to those skilled in the art, and are available by many manufacturers such as Chisso Corporation, Osaka Japan, and Fibervisions LLC of Wilmington, Del.

Cellulosic wood pulps include standard softwood fluffing grade such as CR-1654 (US Alliance Pulp Mills, Coosa, Ala.). Pulp may be modified in order to enhance the inherent characteristics of the fibers and their processability. Curl may be imparted to the fibers by methods including chemical treatment or mechanical twisting. Curl is typically imparted before crosslinking or stiffening. Pulps may be stiffened by the use of crosslinking agents such as formaldehyde or its derivatives, glutaraldehyde, epichlorohydrin, methylolated compounds such as urea or urea derivatives, dialdehydes such as maleic anhydride, non-methylolated urea derivatives, citric acid or other polycarboxylic acids. Some of these agents are less preferable than others due to environmental and health concerns. Pulp may also be stiffened by the use of heat or caustic treatments such as mercerization. Examples of these types of fibers include NHB416 which is a chemically crosslinked southern softwood pulp fibers which enhances wet modulus, available from the Weyerhaeuser Corporation of Tacoma, Wsh. Other useful pulps are fully debonded pulp (NF405) and non-debonded pulp (NB416) and PH Sulfite pulp, also from Weyerhaeuser. HPZ3 from Buckeye Technologies, Inc. of Memphis, Tenn., has a chemical treatment that sets in a curl and twist, in addition to imparting added dry and wet stiffness and resilience to the fiber. Another suitable pulp is Buckeye HPF2 pulp and still another is IP SUPERSOFT® from International Paper Corporation.

It will be appreciated by those of skill in the art that various materials, as well as their amounts, and types, may be utilized according to the present invention to adapt the composite web to a variety applications while remaining within the spirit of the present invention. It will further be appreciated that within the drawing figures the transitions between zones or gradients may be indicated by line drawings, which should not necessarily be taken to indicate sharp transitions in boundaries according to the present invention.

One method of making the absorbent composites of this invention is by the airlaying process using multiple spray heads which are timed and coordinated to aid in placing the various components at certain points along the structure of the web. This may occur in the machine direction MD where zonal separation or intermittent placement along the machine direction occurs as a function of time. Vacuum boxes may be so placed, or obstructed, as to aid in the selective deposition of the various materials on the forming wire, whether differentiated in their machine direction MD or cross direction CD spacing. Compaction rolls, which may be heated, may be used after deposition of the layers to further control the density of the layer and to aid in bonding of the layer.

FIG. 3 shows another aspect of the present invention. A first layer 31 is in an upper layer which may be placed closest to the user. The composition of this layer may be 20% to 80% by weight superabsorbent, 80% to 20% by weight cellulose fiber and 0% to 50% by weight synthetic fibers. In the second, or lower, layer 30 a zone designated B 33 is lies between two second layer zones labeled C 29 and may be arranged to provide some amount of fluid distribution away from the first layer 31. The composition of zone B 33 may be, e.g., from about 30% to about 80% by weight superabsorbent, about 20% to about 70% by weight cellulose fibers and about 0% to 10% by weight synthetic fibers. The zone designated C 29 is at the distal ends of the product The primary function of this zone is to draw liquid towards the end of the product and store it permanently. The composition of this zone may be from 50% to 90% by weight superabsorbent, 10% to 50% by weight cellulose fibers and 0% to about 10% by weight synthetic fibers. Superabsorbents useful in upper layer 31 may have a high gel strength and tend to have high gel bed permeability even when saturated. Examples of such superabsorbents are Favor® 9543 from Stockhausen, Greensboro, N.C. Cellulose fibers for use in upper layer 31 are those that can maintain an open structure when wetted, such as chemically cross linked, mercerized or otherwise stiffened fibers. Examples of such fibers include NHB416 from Weyerhaeuser, Tacoma, Wash. and HPF2 and HPZ3 from Buckeye, Memphis, Tenn. Synthetic fibers useful in the upper layer 31 will also have the ability to maintain an open structure. Such fibers may include, but are not limited to, polyethylene, polypropylene, polyethylene terephthalate (PET), Nylon 6, Nylon 66, acrylic fibers and lyocel fibers, as well as bicomponent fibers in various deniers.

Superabsorbents useful in zone B 33 may have moderate gel strength and tend to exhibit moderate swelling rates. Examples of such superabsorbents include Favor® 880 from Stockhausen, Greensboro, N.C and Drytech®2035 from Dow Chemical, Midland, Mich. Pulp types that may be suitable for use in this zone include conventional southern softwood fibers such as CR54 from Alliance Forest Products, Coosa, Ala., NB416 from Weyerhaeuser, Tacoma, Wash., and Foley fluff from Buckeye, Memphis, Tenn. Synthetic fibers useful in this region preferable have a high level of wettability.

Superabsorbents useful in Zones C 29 outside of zone B 33 in the lower layer 30 may have high fluid retention capacity and moderate to relatively high swelling rates. For example, smaller superabsorbent particles may be used to achieve the high swelling rate. Examples of some superabsorbents which may be useful in zones C 29 include Favor® 880 from Stockhausen, Greensboro, N.C and Drytech® 2035 from Dow Chemical, Midland, Mich. Pulp types useful in this zone are typically fine and highly wettable. Examples include hardwood fibers such as Eucalyptus, Sulfatate HJ from Rayonier, Jesup, Ga. Synthetic fibers, if present in this zone, should be highly wettable and fine denier.

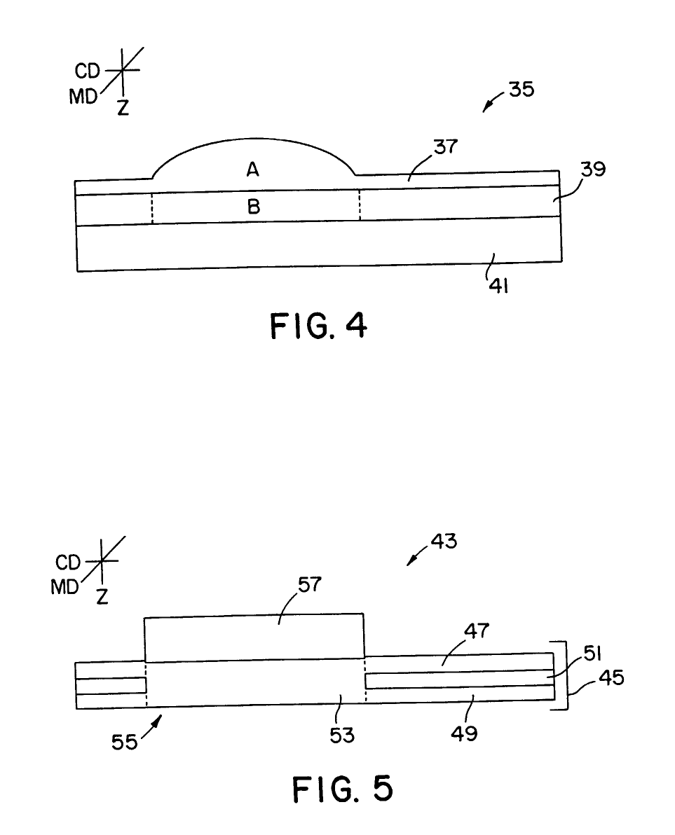

Referencing FIG. 4, a composite web 35 has a top layer 37, an intermediate layer 39, and a bottom layer 41. The top layer 37, may comprise any of the above stated superabsorbent, pulp, and binder constituents, and will have an intermittent density change in zones along the cross direction CD, increasing in area A up to 400 gsm and tapering to about 100 gsm outside the zone of area A. The intermediate layer 39 lays between the top layer 37 and the bottom layer 41 and will have an intermittent material change in zones along the cross direction CD due to an change in the type of superabsorbent materials deposited. In the intermittent zone B, located beneath intermittent zone A of the top layer, a low swell superabsorbent is deposited, whereas the areas outside zone B may have a high swell superabsorbent material. The bottom layer 41 may be constructed of 20 weight percent low swell superabsorbent, 76 weight percent NB416 pulp, and 4 weight percent T255 thermoplastic binder fibers in a 400 gsm layer. Thus it will be appreciated that material and density gradients may exist between zones and non-zones in the cross direction CD, with zones extending at least partially in the machine direction MD, and further in the Z-direction or thickness of the composite web in order to further aid in the efficacy of fluid distribution and retention according to the present invention.

Referencing FIG. 5, there is shown a composite web 43 having a first layer 45 making up an intermittent base layer of the composite web. The first layer 45 is itself a composite of three layers. The three layers may comprise two outside layers 47, 49 consisting substantially of pulp fibers with an inside layer 51 of superabsorbent material between the two outside layers. 47, 49. As the inside layer superabsorbent swells, the outside pulp layers will maintain liquid distribution. A second layer 53 is placed in intermittent zones along the cross direction CD at the bottom 55 of the web 43. The second layer 53 is comprised of 40 weight percent superabsorbent, 56 weight percent pulp, and 4 weight percent T255 binder fibers for a 500 gsm homogeneous layer. The third layer 57 overlays the second layer 53 in the same intermittent zone and is comprised of 50 weight percent superabsorbent, 46 weight percent pulp, and 4 weight percent binder fibers for a 500 gsm layer. Again, it will be appreciated that material and density gradients may exist between and among zones in the cross direction, or CD, with zones extending at least partially the machine direction, or MD, and further in the Z-direction or thickness of the composite web in order to further aid in the efficacy of fluid distribution and retention according to the present invention.

As will be appreciated by those skilled in the art, changes and variations to the invention are considered to be within the ability of those skilled in the art. Such changes and variations are intended by the inventors to be within the scope of the invention.

We claim:

1. An in-line formed, non-laminated web, the web having major surfaces in the X-Y plane and a depth in the Z direction, the web suitable for use as a fluid distribution and fluid retention web in a disposable absorbent article, comprising:
a) multiple layers of composite material;
b) the multiple layers having different compositions;
c) at least two of the multiple layers being in an opposing relation and overlaid in the Z-axis direction of the web thereby creating a gradient in the Z-direction of the web;
d) at least one of the multiple layers having zones of intermittent material deposition in one of a machine direction or a cross direction so as to have discontinuous zones in one of the machine direction or the cross direction; and
e) whereby the composite web has a Z-direction gradient of material layers; and zones of different material layers intermittently placed in one of the machine direction or the cross direction.

2. An in-line formed web suitable for use as a composite fluid distribution and fluid retention layer in a disposable absorbent article according to claim 1, further comprising: the gradient further being in a type of absorbent in each material layer.

3. An in-line formed web suitable for use as a composite fluid distribution and fluid retention layer in a disposable absorbent article according to claim 2, wherein the type of absorbent may be selected between a species of absorbent such as superabsorbent materials or wood pulps, or selected among a varieties of absorbents within such species.

4. An in-line formed web suitable for use as a composite fluid distribution and fluid retention layer in a disposable absorbent article according to claim 1, further comprising: the gradient further being in an amount of absorbent in each material layer.

5. An in-line formed web suitable for use as a composite fluid distribution and fluid retention layer in a disposable absorbent article according to claim 1, wherein the amount of absorbent is varied by weight percent.

6. An in-line formed web suitable for use as a composite fluid distribution and fluid retention layer in a disposable absorbent article according to claim 1, further comprising: the gradient being in a type of thermoplastic fiber in each material layer.

7. An in-line formed web suitable for use as a composite fluid distribution and fluid retention layer in a disposable absorbent article according to claim 6, wherein the gradient is a type of polymer used for the thermoplastic fibers.

8. An in-line formed web suitable for use as a composite fluid distribution and fluid retention layer in a disposable absorbent article according to claim 6, wherein the gradient is a denier of the thermoplastic fibers.

9. An in-line formed web suitable for use as a composite fluid distribution and fluid retention layer in a disposable absorbent article according to claim 1, further comprising: the gradient being in an amount of thermoplastic fiber in each material layer.

10. An in-line formed web suitable for use as a composite fluid distribution and fluid retention layer in a disposable absorbent article according to claim 9, wherein the amount of thermoplastic fiber in each material layer is varied by weight percent.

11. An in-line formed web suitable for use as a composite fluid distribution and fluid retention layer in a disposable absorbent article according to claim 1, further comprising: the gradient being in differing densities of the material layers.

12. An in-line formed web suitable for use as a composite fluid distribution and fluid retention layer in a disposable absorbent article according to claim 1, further comprising: the gradient being in differing thicknesses of the material layers.

13. An in-line formed web suitable for use as a composite fluid distribution and fluid retention layer in a disposable absorbent article according to claim 1, further comprising: the zone further being intermittent in a type of absorbent in each material layer.

14. An in-line formed web suitable for use as a composite fluid distribution and fluid retention layer in a disposable absorbent article according to claim 13, wherein the type of absorbent may be selected between a species of absorbent such as superabsorbent materials or wood pulps, or selected among a varieties of absorbents within such species.

15. An in-line formed web suitable for use as a composite fluid distribution and fluid retention layer in a disposable absorbent article according to claim 1, further comprising: the zone further being intermittent in an amount of absorbent in each material layer.

16. An in-line formed web suitable for use as a composite fluid distribution and fluid retention layer in a disposable absorbent article according to claim 15, wherein the amount of absorbent is varied by weight percent.

17. An in-line formed web suitable for use as a composite fluid distribution and fluid retention layer in a disposable absorbent article according to claim 1, further comprising: the zone being intermittent in a type of thermoplastic fiber in each material layer.

18. An in-line formed web suitable for use as a composite fluid distribution and fluid retention layer in a disposable absorbent article according to claim 17, wherein the gradient is a type of polymer used for the thermoplastic fibers.

19. An in-line formed web suitable for use as a composite fluid distribution and fluid retention layer in a disposable absorbent article according to claim 17, wherein the gradient is a denier of the thermoplastic fibers.

20. An in-line formed web suitable for use as a composite fluid distribution and fluid retention layer in a disposable absorbent article according to claim 1, further comprising: the zone being intermittent in an amount of thermoplastic fiber in each material layer.

21. An in-line formed web suitable for use as a composite fluid distribution and fluid retention layer in a disposable absorbent article according to claim 20, wherein the amount of thermoplastic fiber in each material layer is varied by weight percent.

22. An in-line formed web suitable for use as a composite fluid distribution and fluid retention layer in a disposable absorbent article according to claim 1, further comprising: the zone being intermittent in a differing densities of the material layers.

23. An in-line formed web suitable for use as a composite fluid distribution and fluid retention layer in a disposable absorbent article according to claim 1, further comprising: the zone being intermittent in differing thicknesses of the material layers.

24. An in-line formed web suitable for use as a composite fluid distribution and fluid retention layer in a disposable absorbent article according to claim 1, further comprising: the web having no discrete boundaries between the multiple layers of material.

25. An in-line formed web suitable for use as a composite fluid distribution and fluid retention layer in a disposable absorbent article according to claim 1, further comprising: the web having tissue boundaries between at least some of the multiple layers.

26. An in-line formed web suitable for use as a composite fluid distribution and fluid retention layer in a disposable absorbent article according to claim 1, wherein the material is in the form of air laid material.

27. An in-line formed, non-laminated web, the web having major surfaces in the X-Y plane and a depth in the Z direction, the web suitable for use as a composite fluid distribution and fluid retention layer in a disposable absorbent article, comprising:
a) multiple layers of air laid composite material, at least two of the multiple layers comprising both thermoplastic fibers and absorbent material;
b) the at least two multiple layers having different compositions of thermoplastic fibers and absorbent material;
c) the at least two multiple layers being in an opposing and adjacent relation and overlaid in the Z-axis direction of the web thereby creating a gradient in the Z-direction of the web;
d) at least one of the multiple layers having zones of intermittent material deposition in one of a machine direction or a cross direction so as to have discontinuous zones in one of the machine direction or the cross direction;
e) the web having no discrete boundaries between the multiple layers of air laid material; and
f) whereby the composite web has a Z-direction gradient of air laid material layers; and zones of different material layers intermittently placed in one of the machine direction or the cross direction.

28. An in-line formed non-laminated web, the web having major surfaces in the X-Y plane and a depth in the Z direction, the web suitable for use as a composite fluid distribution and fluid retention layer in a disposable absorbent article, comprising:
a) multiple layers of air laid composite material comprising both thermoplastic fibers and absorbent material;
b) the multiple layers creating gradients in the Z-direction having different compositions of thermoplastic fibers and absorbent material including at least one of a different composition selected from the group including: a type of absorbent in each air laid material layer, an amount of absorbent in each air laid material layer, a type of thermoplastic fiber in each air laid material layer, an amount of thermoplastic fiber in each air laid material layer, differing densities of the air laid material layers, and differing thicknesses of the air laid material layers;
c) at least two of the multiple layers being in an opposing and adjacent relation and overlaid in the Z-axis direction of the web thereby creating a gradient in the Z-direction of the web;
d) at least one of the multiple layers having zones of intermittent material deposition in one of a machine direction or a cross direction so as to have discontinuous zones in one of the machine direction or the cross direction; and
e) whereby the composite web has a Z-direction gradient of air laid material layers; and zones of different material layers intermittently placed in one of the machine direction or the cross direction.

29. An in-line formed non-laminated web, the web having major surfaces in the X-Y plane and a depth in the Z direction, the web suitable for use as a composite fluid distribution and fluid retention layer in a disposable absorbent article, comprising:
a) multiple layers of air laid composite material comprising both thermoplastic fibers and absorbent material;
b) at least one of the multiple layers having zones of intermittent composition change of thermoplastic fibers, or absorbent material, or both, including at least one of a different composition selected from the group including the zones being intermittent in a type of absorbent in each air laid material layer, being intermittent in an amount of absorbent in each air laid material layer, being intermittent in a type of thermoplastic fiber in each air laid material layer, being intermittent in an amount of thermoplastic fiber in each air laid material layer, being intermittent in differing densities of the air laid material layers, and being intermittent in differing thicknesses of the air laid material layer;
c) at least two of the multiple layers being in an opposing and adjacent relation and overlaid in the Z-axis direction of the web thereby creating a gradient in the Z-direction of the web;
d) at least one of the multiple layers having zones of intermittent material deposition in one of a machine direction or a cross direction so as to have discontinuous zones in one of the machine direction or the cross direction; and
e) whereby the composite web has a Z-direction gradient of air laid material layers; and zones of different material layers intermittently placed in one of the machine direction or the cross direction.

30. An in-line formed non-laminated web, the web having major surfaces in the X-Y plane and a depth in the Z direction, the web suitable for use as a composite fluid distribution and fluid retention layer in a disposable absorbent article, comprising:
a) multiple layers of air laid composite material comprising both thermoplastic fibers and absorbent material;
b) the multiple layers having different compositions of thermoplastic fibers and absorbent material including two or more different compositions selected from the group including: a type of absorbent in each air laid material layer, an amount of absorbent in each air laid material layer, a type of thermoplastic fiber in each air laid material layer, an amount of thermoplastic fiber in each air laid material layer, differing densities of the air laid material layers, and differing thicknesses of the air laid material layer, the zones being intermittent in a type of absorbent in each air laid material layer, being intermittent in an amount of absorbent in each air laid material layer, being intermittent in a type of thermoplastic fiber in each air laid material layer, being intermittent in an amount of thermoplastic fiber in each air laid material layer, being intermittent in differing densities of the air laid material layers, being intermittent in differing thicknesses of the air laid material layer;
c) at least two of the multiple layers being in an opposing and adjacent relation and overlaid in the Z-axis direction of the web thereby creating a gradient in the Z-direction of the web;
d) at least one of the multiple layers having zones of intermittent material deposition in one of a machine direction or a cross direction so as to have discontinuous zones in one of the machine direction or the cross direction; and
e) whereby the composite web has a Z-direction gradient of air laid material layers; and zones of different material layers intermittently placed in one of the machine direction or the cross direction.
